(19) United States
(12) Patent Application Publication
(10) Pub. No.: US 2003/0156824 A1
(43) Pub. Date: Aug. 21, 2003

(54) Simultaneous viewing of time divided segments of a tv program

(75) Inventor: Jin Lu, Croton-on-Hudson, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V.

(21) Appl. No.: 10/081,892

(22) Filed: Feb. 21, 2002

(51) Int. Cl. H04N 5/91

(52) U.S. Cl. 386/68

(57) ABSTRACT

A single video program is divided into multiple segments, with at least one frame from each segment concurrently displayed each within a different display portion of a total display area. The segments may be concurrently played within the different display areas to permit quick location of particular scenes. The number of segments, the length of uniform segments, or the number of segments and their corresponding lengths may be varied by the user. User controls also permit selection or modification of particular segments during concurrent displays.

### TECHNICAL FIELD OF THE INVENTION

The present invention is directed, in general, to viewing stored video content and, more specifically, to nonlinear viewing of video content such as concurrent viewing of multiple segments.

### BACKGROUND OF THE INVENTION

Video programs may be stored in a personal video recorder (PVR) or video cassette recorder (VCR) and then later retrieved for viewing at any time. Similarly, the content stored on a digital versatile disk (DVD) may be retrieving for viewing at any time. In either instance, the stored content may be viewed in many ways, the most common of which is in “one dimension”—that is, linearly from start to end in the regular manner in which the content was intended to be viewed, with possible fast-forwarding (or fast “rewinding”) through or past selected scenes. Digital versatile disks add the ability to begin viewing the content at any of a number of intermediate break points (“chapters”), but are still limited to one-dimensional, linear viewing from such break points.

Contemporary viewers are increasingly sophisticated, and may not be satisfied if limited to conventional one-dimensional viewing of video content. Concurrent viewing or display of noncontiguous scenes within video content may be desired by such users for reasons such as comparison or artistic analysis. Additionally, fast location of particular scenes within the video content may be desirable for a variety of reasons such as copying for incorporation into another video work or exclusion from an edited version of the stored video content (e.g., removal of commercial advertisements).

There is, therefore, a need in the art for improved, nonlinear display of stored video content in a flexible manner allowing multiple segments to be concurrently displayed.

### SUMMARY OF THE INVENTION

To address the above-discussed deficiencies of the prior art, it is a primary object of the present invention to provide, for use in a video system, a controller dividing a single video program into multiple segments, with at least one frame from each segment concurrently displayed each within a different display portion of a total display area. The segments may be concurrently played within the different display areas to permit quick location of particular scenes. The number of segments, the length of uniform segments, or the number of segments and their corresponding lengths may be varied by the user. User controls also permit selection or modification of particular segments during concurrent displays.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 depicts a video system supporting concurrent display of time divided video segments from a single piece of video content according to one embodiment of the present invention;

FIGS. 2A through 2D illustrate concurrent displays of time divided video segments from a single piece of video content according to one embodiment of the present invention; and

FIG. 3 is a high level flow chart for a process of concurrently displaying time divided video segments from a single piece of video content according to one embodiment of the present invention.

### DETAILED DESCRIPTION OF THE INVENTION

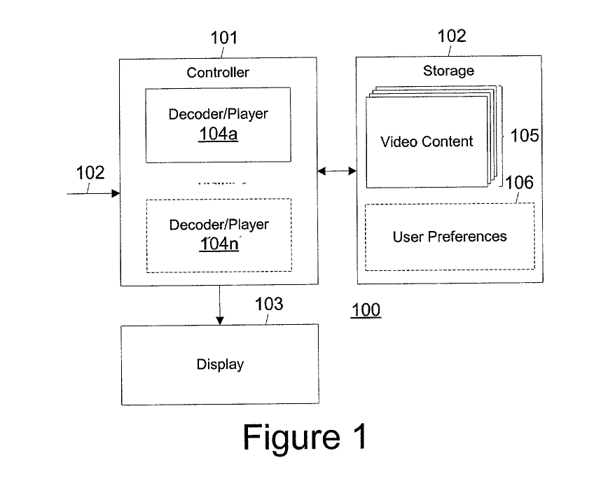

FIGS. 1 through 3, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device.

FIG. 1 depicts a video system supporting concurrent display of time divided video segments from a single piece of video content according to one embodiment of the present invention. Video system 100 may be implemented within or comprise a video receiver such as a satellite, terrestrial or cable broadcast television receiver or a set-top box, a video recording and/or playback device such as a video cassette recorder, digital video recorder or digital versatile disk player, or some combination of such devices.

Video system 100 includes a controller 101 having an input 102 for receiving control signals such a infrared remote control signals. Controller 101 is coupled to a memory 102 or other storage (e.g., a hard disk drive or digital versatile disk drive and disk), which may optionally be disposed within a separate device from controller 101. Controller 101 also includes a display 103 in the exemplary embodiment, although controller 101 may include an output connection (not shown) to a separate device having a display in lieu of, or in addition to, the display 103.

Controller 101 includes at least on video decoder and/or player 104a, and may include up to n (where n is any positive integer) video decoders/players 104a-104n. Storage 102 contains one or more items of video content 105, such stored programs demodulated and recorded from a broadcast or a Motion Pictures Expert Group (MPEG) encoded program on a digital versatile disk. Storage 102 may also optionally contain a set of user preferences 105 regarding display of video content in accordance with the present invention, as described in further detail below.

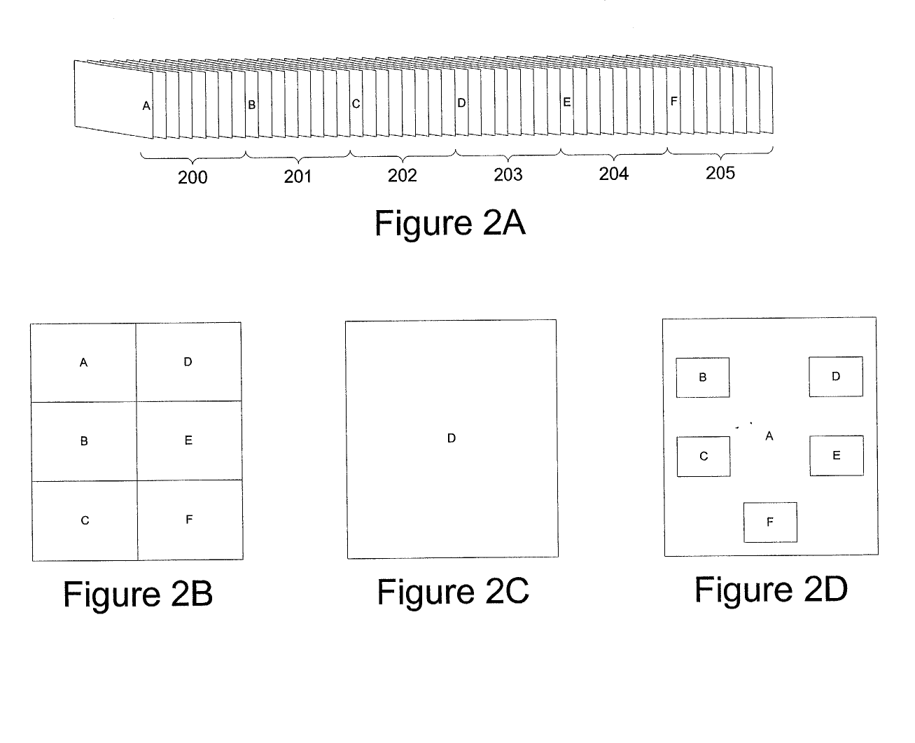

FIGS. 2A through 2D illustrate concurrent displays of time divided video segments from a single piece of video content according to one embodiment of the present invention, and are intended to be read in conjunction with FIG. 1. With the present invention, controller 101 enables two-dimensional viewing of video content wherein various different segments from a single item of video content are concurrently displayed.

For example, a ninety minute video program, depicted in FIG. 2A as a sequence of fields or frames, may be divided by controller 101 into six sequential segments 200-205 as shown in FIG. 2A, each 15 minutes long, with the first field or frame for each segment 200-205 marked with an alphabetic letter. Controller 101 locates the beginning of each segment (in a memory or on a hard disk, digital versatile disk, or video tape), then creates six windows within the viewable display area and displays at least a first frame or field from each of the six segments 200-205, one in each window as shown in FIG. 2B.

Controller 101 may display either a single field or frame from each segment as a still image, or may concurrently play each segment within the respective windows utilizing one decoder/player 104a-104n for each window. If only a single decoder/player is available, multiplexing may be employed, either to maintain play of all six segments if possible or to alternately play one video segment in sequence for a period of time before playing the next video segment. The frame in each window should be updated once every 1/30^{th} of a second to provide simultaneous play of multiple segments.

Where multiple segments are concurrently played, a single audio track associated with one of the segments may be played, or audio tracks from two segments may be concurrently played on left and right audio channels.

Concurrent display of different segments from a single video program allows the viewer to quickly locate portions of interest or, alternatively, “boring” or uninteresting portions such as commercials. Once interesting portions are identified, the viewer can quickly focus on such segments by zooming in those segments on and replaying them in the full display area as shown in FIG. 2C (where segment 203 has been selected and “zoomed in” on by the user), with the remaining segments removed. Similarly, uninteresting portions may be marked for skipping during subsequent replays or copying of the video program.

Other display configurations may be supported by controller 101, such as the full area display with small, overlying insets illustrated in FIG. 2D, where one segment is played (or represented by a still image) in the full area display and the remaining segments played or represented by a still image in each of the insets, in the manner of a picture-in-picture (PIP) display. The viewer may switch between the views of FIGS. 2B and 2D, and swap the segment displayed in the full area display with a segment displayed in an inset.

Alternatively, where the display area is equally divided for each segment, one or more segments may be removed from the display to allow the remaining windows to have more space within the display area. The full display area may also be utilized, with the segment displayed alternating cyclically through the available segments 200-205 in a periodic, round-robin manner.

When concurrently displayed, segments 200-205 may be played in either forward or reverse, paused or “frozen” to a still image to be restarted later. Control actions such as fast-forward, fast-reverse, or pause may operate on all segments identically, or may operate only on individual, selected segments. Two or more selected (contiguous or noncontiguous) segments may be combined or merged into a single segment, which continues playing after the remaining segments have ended. One selected segment (or all segments 200-205) may be further subdivided into smaller segments, which are then displayed.

Moreover, while the video program is divided into six, uniformly sized segments in the exemplary embodiment, any positive integer number of segments may be created, and the sizes need not be uniform. In this regard, the user preferences 105 may specify the number of segments and/or the length of segments (either the length of equal size segments into which the video program should be divided or the length of each of a defined number of segments). For instance, in editing a video program to remove commercial advertisements, the video program may be segmented in a fashion most likely to enable quick identification of the commercials (e.g., segments selected to start near portions of the video program likely to contains commercials). Edits to one video program may be utilized to create a template for segmenting other video programs of a similar type.

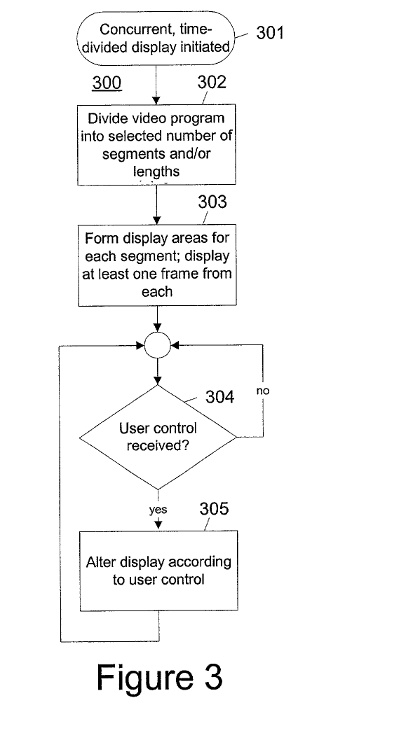

FIG. 3 is a high level flow chart for a process of concurrently displaying time divided video segments from a single piece of video content according to one embodiment of the present invention. The process 300, executed within controller 101 in FIG. 1, begins with concurrent display of time-divided segments from a selected video program being initiated (step 301).

The number of segments, the length of each segment, or the number of segments and associated lengths of each segment is first determined and the selected video program divided into the appropriate segments (step 302). Display areas for each segment are then formed within the total display area, and at least one frame from each segment is displayed in the corresponding display area (step 303). The process then monitors for user controls (step 304) such as stop, pause, resume, zoom, etc., and implements the appropriate action when a user control is detected (step 305). The process continues until interrupted or terminated by an external process.

Referring once again to FIG. 1, where storage 102 is located within a device separate from controller 101 (e.g., one or more video players), controller 101 should include an interface to the video player to inform the video player(s) of the locations and lengths of segments to be player, as well as to communicate control signals to stop and resume the player(s).

The present invention enables two-dimensional viewing of video content for quick location of particular scenes therein, or for other purposes. Segmentation of a video program for concurrent display of different segments, either discrete or overlapping, allows greater flexibility to video program viewing.

It is important to note that while the present invention has been described in the context of a fully functional system, those skilled in the art will appreciate that at least portions of the mechanism of the present invention are capable of being distributed in the form of a machine usable medium containing instructions in a variety of forms, and that the present invention applies equally regardless of the particular type of signal bearing medium utilized to actually carry out the distribution. Examples of machine usable mediums include: nonvolatile, hard-coded type mediums such as read only memories (ROMs) or erasable, electrically programmable read only memories (EEPROMs), recordable type mediums such as floppy disks, hard disk drives and compact disc read only memories (CD-ROMs) or digital versatile discs (DVDs), and transmission type mediums such as digital and analog communication links.

Although the present invention has been described in detail, those skilled in the art will understand that various changes, substitutions, variations, enhancements, nuances, gradations, lesser forms, alterations, revisions, improvements and knock-offs of the invention disclosed herein may be made without departing from the spirit and scope of the invention in its broadest form.

What is claimed is:

1. A video system comprising:
a controller coupled to a storage medium containing a single video program, the controller time-dividing the video program into a plurality of segments and initiating concurrent display of each segment in a different display portion of a display area.

2. The video system according to claim 1, wherein the video program is divided into one of a predetermined number of equal size segments, a number of segments having a predetermined size plus any remainder, and a predetermined number of segments each having an associated predetermined size.

3. The video system according to claim 1, wherein the display area is divided into one of equal size display portions for each of the segments and a full area display portion for one segment with overlying insets for each of a remainder of the segments.

4. The video system according to claim 1, wherein each of the segments is concurrently played within the respective display portion.

5. The video system according to claim 1, wherein user controls enable one of playing, stopping, pausing, resuming playing, fast forwarding, fast reversing, and zooming of one or more segments while the segments are concurrently displayed within the display area.

6. A video system comprising:
a storage medium containing at least one video program;
a display including a display area; and
a controller coupled to the storage medium and the display and processing a single selected video program for display in the display area, the controller time-dividing the selected video program into a plurality of segments and initiating concurrent display of each segment in a different display portion of the display area.

7. The video system according to claim 6, wherein the selected video program is divided into one of a predetermined number of equal size segments, a number of segments having a predetermined size plus any remainder, and a predetermined number of segments each having an associated predetermined size.

8. The video system according to claim 6, wherein the display area is divided into one of equal size display portions for each of the segments and a full area display portion for one segment with overlying insets for each of a remainder of the segments.

9. The video system according to claim 6, wherein each of the segments is concurrently played within the respective display portion.

10. The video system according to claim 6, wherein user controls enable one of playing, stopping, pausing, resuming playing, fast forwarding, fast reversing, and zooming of one or more segments while the segments are concurrently displayed within the display area.

11. A method of video content display comprising:
selecting a single video program;
time-dividing the selected video program into a plurality of segments; and
initiating concurrent display of each segment in a different display portion of a display area.

12. The method according to claim 11, wherein the step of time-dividing the selected video program into a plurality of segments further comprises:
dividing the video program into one of a predetermined number of equal size segments, a number of segments having a predetermined size plus any remainder, and a predetermined number of segments each having an associated predetermined size.

13. The method according to claim 11, further comprising:
dividing the display area into one of equal size display portions for each of the segments and a full area display portion for one segment with overlying insets for each of a remainder of the segments.

14. The method according to claim 11, further comprising:
concurrently playing each of the segments within the respective display portion.

15. The method according to claim 11, further comprising:
providing user controls enabling one of playing, stopping, pausing, resuming playing, fast forwarding, fast reversing, and zooming of one or more segments while the segments are concurrently displayed within the display area.

16. A video signal comprising:
video information for a display area, the video information including images corresponding to at least one frame from each of a plurality of time-divided segments from a single video program combined for concurrent display of each segment in a different display portion of the display area.

17. The video signal according to claim 16, wherein the video information includes images corresponding to one of a predetermined number of equal size segments of the video program, a number of segments of the video program each having a predetermined size plus any remainder, and a predetermined number of segments of the video program each having an associated predetermined size.

18. The video signal according to claim 16, wherein the video information contains images for one of equal size display portions for each of the segments and a full area display portion for one segment with overlying insets for each of a remainder of the segments.

19. The video signal according to claim 16, wherein the video information contains images corresponding to concurrently playing each of the segments within the respective display portion.

20. The video signal according to claim 16, wherein the video information changes in response to user controls for one of playing, stopping, pausing, resuming playing, fast forwarding, fast reversing, and zooming of one or more segments while the segments are concurrently displayed within the display area.
